(19) United States
(12) Patent Application Publication
(10) Pub. No.: US 2015/0367580 A1
(43) Pub. Date: Dec. 24, 2015

(54) THREE-DIMENSIONAL SHAPING APPARATUS AND METHOD FOR CALIBRATING THE SAME

(71) Applicant: MUTOH INDUSTRIES LTD., Tokyo (JP)

(72) Inventor: Takashi Touma, Tokyo (JP)

(21) Appl. No.: 14/745,309

(22) Filed: Jun. 19, 2015

(30) Foreign Application Priority Data
Jun. 20, 2014 (JP) 2014-126821

(51) Int. Cl. B29C 67/00; G05B 19/4099

(52) U.S. Cl. CPC B29C 67/0088; G05B 19/4099; B33Y 30/00

(57) ABSTRACT

A three-dimensional shaping apparatus according to the present invention includes a shaping stage, an ascending/descending unit, a shaping head, a light sensor, and a light source. The shaping stage is configured to carry a shaped object. The ascending/descending unit is movable at least along a vertical direction with respect to the shaping stage. The shaping head is mounted on the ascending/descending unit. The light source is configured to emit light directed toward the light sensor. One of either the light sensor or the light source is mounted movable in accordance with movement of the ascending/descending unit, while the other of either the light sensor or the light source is disposed fixedly relative to the shaping stage.

### TECHNICAL FIELD

The present invention relates to a three-dimensional shaping apparatus and a method for calibrating the three-dimensional shaping apparatus.

### DESCRIPTION OF THE RELATED ART

A three-dimensional shaping apparatus that manufactures three-dimensional shaped objects (hereinafter simply referred to as shaped objects) based on three-dimensional design data has been known by, for example, Japanese Unexamined Patent Application Publication No. 2013-43338. As a method for such three-dimensional shaping apparatus, various methods such as a stereolithography, a powder sintering method, an ink-jet method, and a molten resin extrusion shaping method have been proposed, and the three-dimensional shaping apparatus has been developed into a product.

As one example, the three-dimensional shaping apparatus using the molten resin extrusion shaping method mounts a shaping head to eject a molten resin, which is a material for shaped objects, on a three-dimensional moving mechanism. While moving the shaping head in a three dimensional direction to eject the molten resin, the three-dimensional shaping apparatus laminates the molten resin to obtain the shaped objects. Besides, a three-dimensional shaping apparatus employing the ink-jet method also has a structure of mounting a shaping head to drop heated thermoplastic materials on the three-dimensional moving mechanism.

Thus, to exactly shape the shaped objects into the three-dimensional design data by the three-dimensional shaping apparatus that moves the shaping head to shape the shaped objects, it is necessary to accurately move the shaping head to a desired position based on the three-dimensional design data.

However, with the conventional three-dimensional shaping apparatus of the identical type, a shaping space coordinate system specified by a mechanism to move the shaping head in the three dimensional direction possibly shift from a coordinate system specifying the three-dimensional design data, which is original data. Such shift between two coordinate systems possibly changes as time goes on. The conventional three-dimensional shaping apparatus does not consider this sort of shift. Therefore, the conventional three-dimensional shaping apparatus has a problem of difficultly in shaping exact to the original data.

An object of the present invention is to provide a three-dimensional shaping apparatus that comprehends a shaping space coordinate to ensure shaping exact to original data.

### SUMMARY

A three-dimensional shaping apparatus according to the present invention includes a shaping stage, an ascending/descending unit, a shaping head, a light sensor, and a light source. The shaping stage is configured to carry a shaped object. The ascending/descending unit is movable at least along a vertical direction with respect to the shaping stage. The shaping head is mounted on the ascending/descending unit. The light source is configured to emit light directed toward the light sensor. One of either the light sensor or the light source is mounted movable in accordance with movement of the ascending/descending unit, while the other of either the light sensor or the light source is disposed fixedly relative to the shaping stage.

### BRIEF DESCRIPTION OF THE DRAWINGS

FIG. 1 is a perspective view illustrating a schematic configuration of a three-dimensional shaping apparatus according to a first embodiment;

FIG. 2 is a front view illustrating a schematic configuration of the three-dimensional shaping apparatus according to the first embodiment;

FIG. 3 is a perspective view illustrating a configuration of an XY stage 12;

FIG. 4 is a plan view illustrating a configuration of an ascending/descending table 14;

FIG. 5 is a conceptual diagram illustrating a problem of a conventional three-dimensional shaping apparatus;

FIG. 6 is a perspective view illustrating an arrangement of a laser light source 16 and a light sensor 17;

FIG. 7 is a function block diagram illustrating a configuration of a computer 200;

FIG. 8 is a flowchart illustrating operations by the three-dimensional shaping apparatus of the first embodiment;

FIG. 9 is a conceptual diagram illustrating operations of the three-dimensional shaping apparatus of the first embodiment;

FIG. 10 is a function block diagram illustrating a configuration of a three-dimensional shaping apparatus of a second embodiment;

FIG. 11 is a flowchart illustrating operations by the three-dimensional shaping apparatus of the second embodiment;

FIG. 12 is a function block diagram illustrating a configuration of a three-dimensional shaping apparatus of a third embodiment; and

FIG. 13 illustrates a modification of the embodiments of the present invention.

### DETAILED DESCRIPTION

The following describes embodiments of the present invention in detail with reference to the drawings.

### First Embodiment

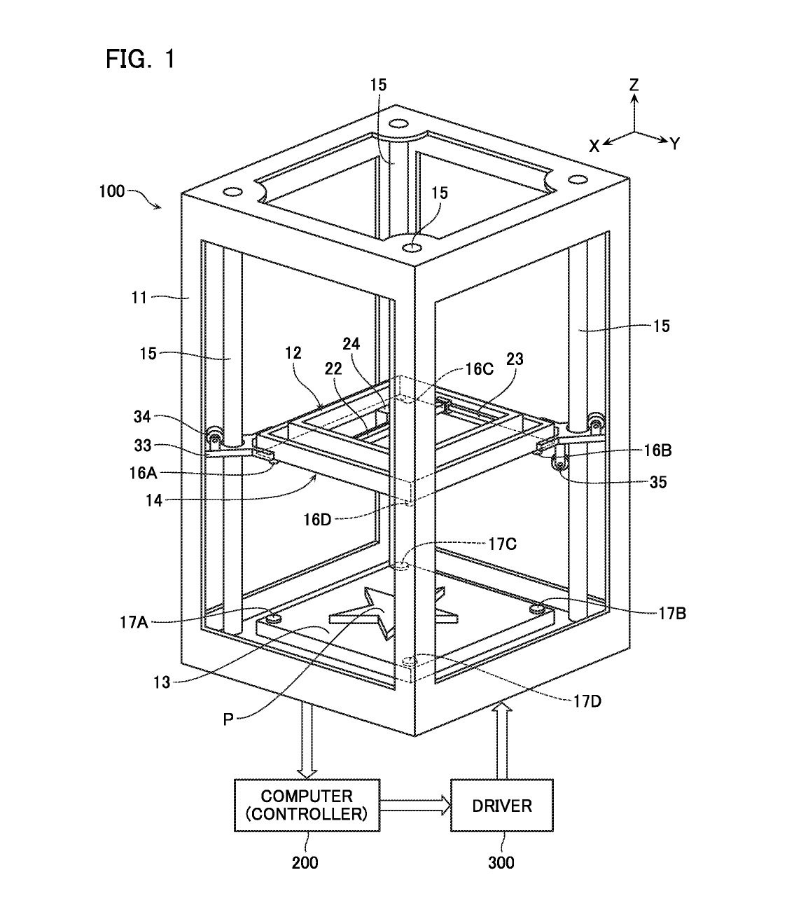

First, with reference to FIG. 1 to FIG. 7, the following describes a three-dimensional shaping apparatus according to the first embodiment.

FIG. 1 is a perspective view illustrating a schematic configuration of a 3D printer 100 included in the three-dimensional shaping apparatus of the first embodiment. As illustrated in FIG. 1, the 3D printer 100 includes a frame 11, an XY stage 12, a shaping stage 13, an ascending/descending table 14, guide shafts 15, laser light sources 16A to 16D, and light sensors 17A to 17D. As a controller to control this 3D printer 100, a computer 200 is coupled to this 3D printer 100. A driver 300 to drive various mechanisms in the 3D printer 100 is also coupled to this 3D printer 100.

As illustrated in FIG. 1, the frame 11 has, for example, a rectangular parallelepiped outer shape. The frame 11 has a framework made of a metallic material such as aluminum. At four corner portions of this frame 11, for example, four pieces of the guide shafts 15 are formed. The guide shafts 15 extend in the Z direction in FIG. 1, that is, the direction vertical to the plane of the shaping stage 13. The guide shafts 15 are, as described later, linear members that specify a direction of moving the ascending/descending table 14 in the vertical direction. The count of the guide shafts 15 is not limited to four pieces. The count of the guide shafts 15 is set to a count where the ascending/descending table 14 can be stably maintained and moved. The shaping stage 13 is a base on which a shaped object P is to be formed. Specifically, the shaping stage 13 is the base on which thermoplastic resin extracted from a shaping head, which will be described later, is to be deposited.

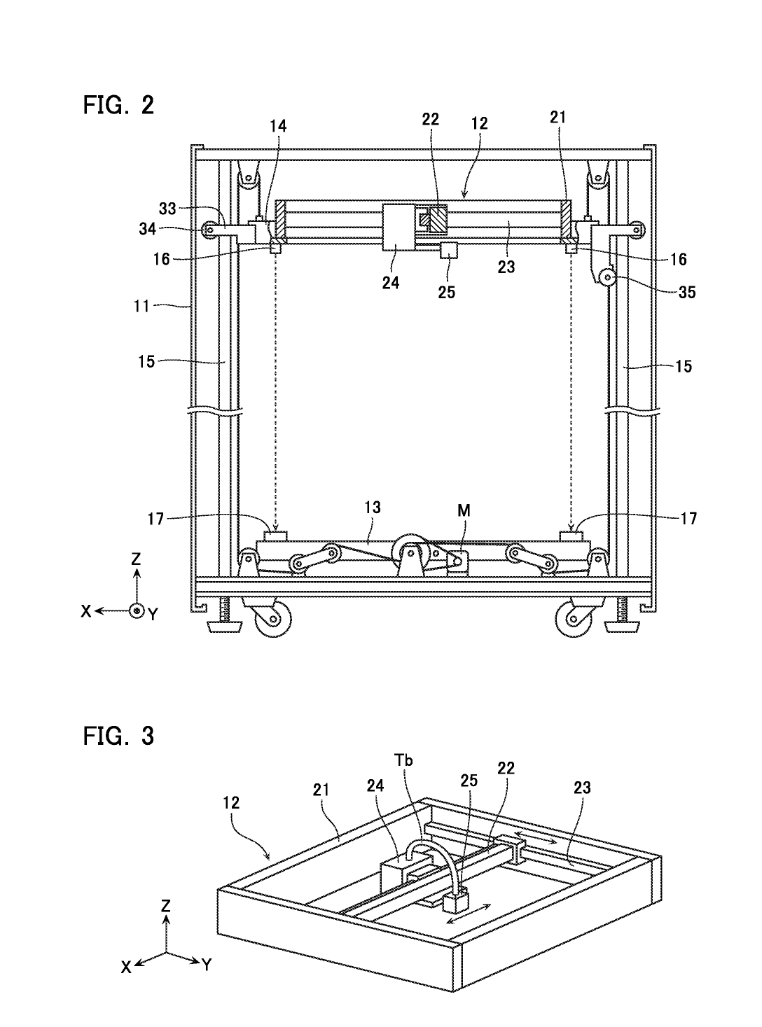

As illustrated in FIG. 1 and FIG. 2, the ascending/descending table 14 causes the guide shafts 15 to pass through at the four corner portions. The ascending/descending table 14 is movably configured along a longitudinal direction (Z direction) of the guide shafts 15. The ascending/descending table 14 has rollers to be in contact with the guide shafts 15. Through these rollers rotate while in contact on the guide shafts 15, the ascending/descending table 14 can smoothly move in the Z direction. As illustrated in FIG. 2, transmission of a driving power from a motor M through a power transmission mechanism formed of such as a timing belt, a wire, and a pulley, the ascending/descending table 14 vertically moves at predetermined intervals (for example, 0.1-mm pitches). The motor M is preferably, for example, a servo motor and a stepping motor.

The XY stage 12 is placed on the top surface of this ascending/descending table 14. FIG. 3 is a perspective view illustrating the schematic configuration of this XY stage 12. The XY stage 12 includes a framing body 21, an X guide rail 22, a Y guide rail 23, a filament holder 24, and a shaping head 25. Both ends of the X guide rail 22 are engaged by the Y guide rail 23 to be slidably held in the Y direction. The filament holder 24 is a container to hold the thermoplastic resin, which becomes the material for the shaped objects. The thermoplastic resin is supplied from the filament holder 24 to the shaping head 25 via a tube Tb. The shaping head 25 is movably configured together with the filament holder 24 along the X and Y guide rails 22 and 23.

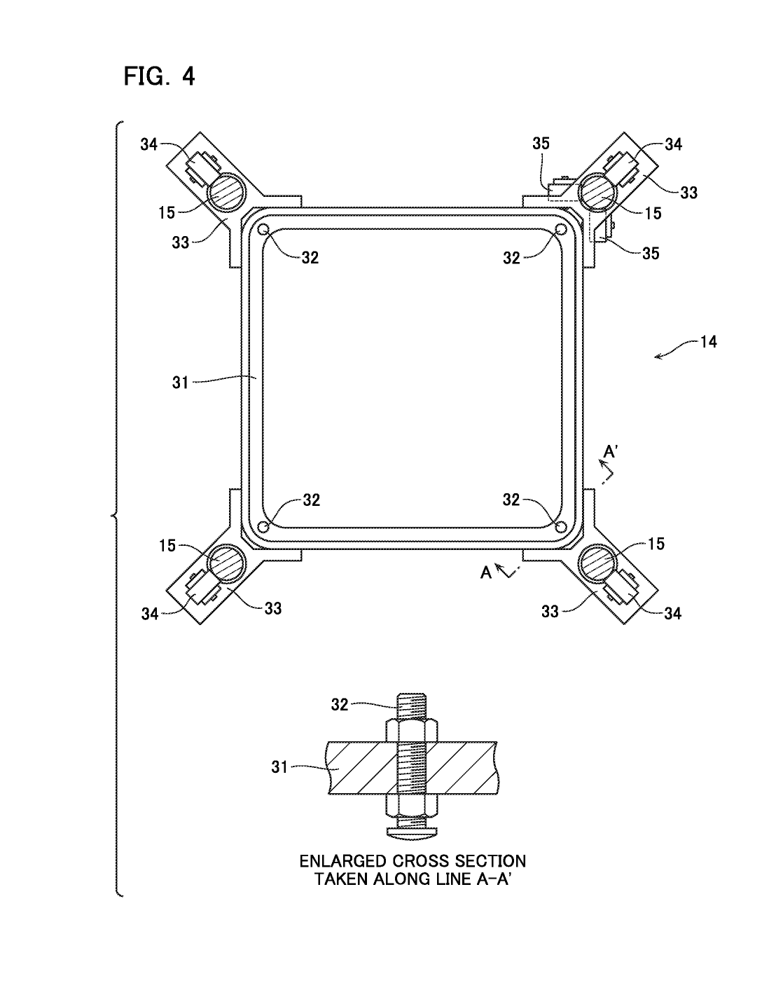

FIG. 4 is a plan view illustrating an exemplary, specific structure of the ascending/descending table 14. The ascending/descending table 14 in the example in FIG. 4 includes a framing body 31, height adjustment pins 32, slide frames 33, driven rollers 34, and fixed rollers 35. As illustrated in FIG. 4, the framing body 31 has a closed rectangular loop shape. The framing body 31 is internally hollow for operation of the XY table 12. For example, four pieces of the height adjustment pins 32 are formed on the top surface of the framing body 31. The height adjustment pins 32 are configured such that the height positions of the top surfaces can be each adjusted individually. The adjustment of the heights of these four pieces of height adjustment pins 32 adjusts the XY table 12, which is placed on the top surfaces of these height adjustment pins 32, in a direction parallel to the shaping stage 13.

The slide frame 33 has an approximately Y shape. The slide frames 33 are secured to the framing body 31 by, for example, tightening screws at the two sides at the Y frames. The slide frame 33 has a through-hole to pass through the guide shaft 15. The driven roller 34 and the fixed roller 35 are installed to the slide frame 33 so as to be in contact with the guide shaft 15 at the sidewall of this through-hole. The rotation shaft of the fixed roller 35 is fixedly secured to the slide frame 33. Meanwhile, a range of motion is provided to the rotation shaft of the driven roller 34 with respect to the slide frame 33 with a spring mechanism (not illustrated). Moreover, the driven rollers 34 are configured so as to be in contact with the guide shaft 15 with pressing force.

In the example of FIG. 4, both the fixed rollers 35 and the driven roller 34 are disposed only at one of the slide frames 33 at the upper right. Only the driven rollers 34 are disposed at the remaining three slide frames 33. This is for ease of adjustment in the case where a principal plane of the ascending/descending table 14 is adjusted parallel to a reference plane. A horizontal extraction operation of the ascending/descending table 14 can be performed by using, for example, a wire tension control mechanism (not illustrated) disposed inside the above-described power transmission mechanism. Needless to say, disposing both the fixed rollers 35 and the driven rollers 34 at the all slide frames 33 is also possible.

The three-dimensional shaping apparatus with the above-described configuration is preferably configured as follows. The XY stage 12 is installed parallel to the shaping stage 13 on the XY plane. The guide shafts 15 linearly extend parallel to the Z direction. However, it is difficult to form and install the guide shafts 15 so as to accurately go along the Z direction and linearly extend accurately. Additionally, the shape of the guide shaft 15 possibly changes as time goes on. Especially, this tendency is remarkable particularly in the case where the three-dimensional shaping apparatus becomes a large size, the length of the guide shaft 15 lengthens, or the weight of the filament holder 24 placed on the XY stage 12 or a similar component increases.

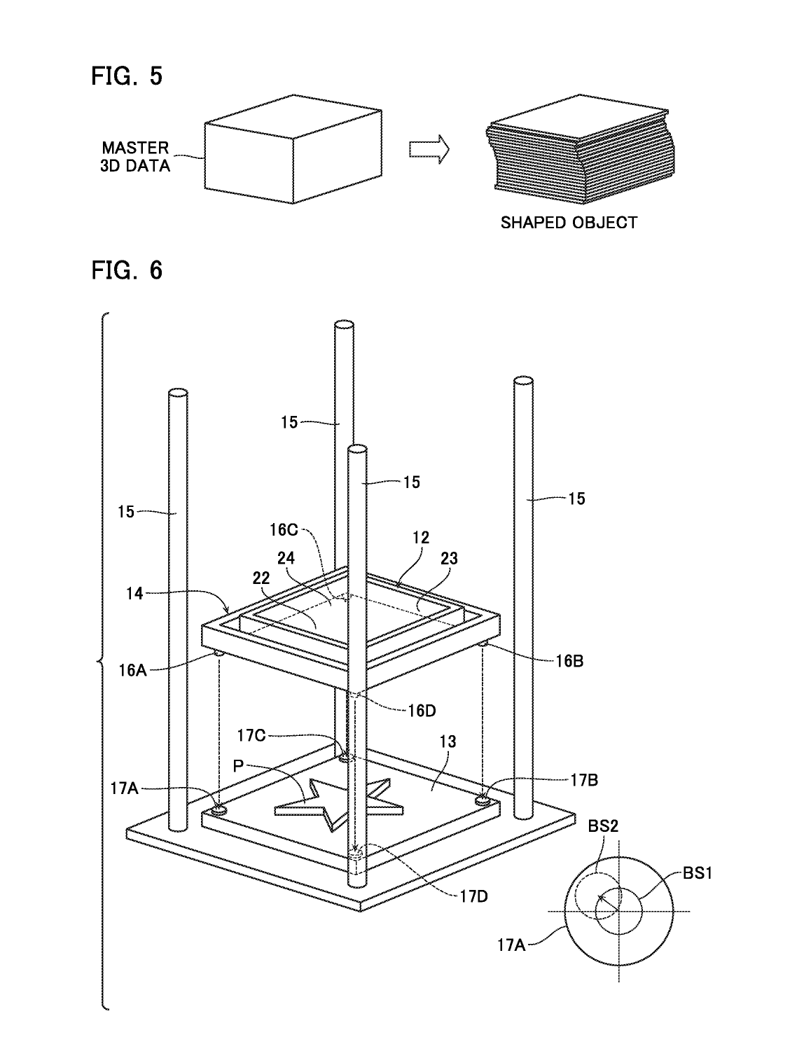

Assume the case where the shape of the guide shaft 15 changes and therefore the shape of the frame 11 of the 3D printer 100 is totally distorted. Even if three-dimensional CAD data (master 3D data) provided to the computer 200 has the rectangular parallelepiped shape as illustrated in FIG. 5 to the left, the shaped object to be shaped possibly does not become the shape exact to the original data as illustrated in FIG. 5 to the right. FIG. 5 illustrates the shift in the X-Y direction. In addition to this, the coordinate system for the shaping space of the 3D printer 100 is possibly inclined entirely or partially. This inclination also possibly results in failing to shape the shaped object exact to the shape of the original data.

Therefore, the three-dimensional shaping apparatus according to the embodiment includes the laser light source 16 (16A to 16D) and a light sensor 17 (17A to 17D) as illustrated in FIG. 6. The laser light source 16 and the light sensor 17 detect a deformation (a distortion, an inclination, or a similar deformation) of the three-dimensional shaping apparatus including the guide shafts 15. While moving the ascending/descending table 14, the three-dimensional shaping apparatus obtains the detection signals from these light sensors 17 and measures changes in the detection signals. For example, assume the case where the frame 11 of the 3D printer 100 is, for example, distorted. Then, as the ascending/descending table 14 moves, a light receiving position by the light sensor 17, for example, as illustrated in the lower right in FIG. 6, moves, for example, from a position BS1 to a position BS2. Such change in the light receiving position appears as a difference in the detection signal. Based on the change in the sensing signal from the light sensor 17, the three-dimensional shaping apparatus according to the embodiment performs an operation of correcting slice data in an operation of converting the master 3D data into the slice data as described later. Thus, even if the coordinate system for the shaping space (shaping space coordinate system) specified by the three-dimensional shaping apparatus is shifted from the reference coordinate system specifying the master 3D data, to eliminate an influence due to this shift, data such as the slice data is corrected. This allows accurate shaping operation, even if the configuration in the 3D printer 100 such as the guide shaft 15 is distorted and inclined and this generates some shift in the shaping space coordinate system. In other words, this configuration, for example, eliminates the need for requiring accuracy on the form more than necessary to a steel member such as the guide shaft 15 and assembly accuracy. This allows ensuring low-price products and also allows facilitating maintenance work of the products. The laser light sources 16A to 16D may be always driven so as to emit light all the time. The laser light sources 16A to 16D may also be pulse-driven so as to emit the light at a predetermined frequency. The pulse-driven laser light sources 16A to 16D can reduce the power consumption and can restrain disturbance noise and therefore are preferable.

In the example of FIG. 6, the counts of the laser light sources 16 and the light sensors 17 are each four pieces; however, this should not be construed in a limiting sense. Depending on a kind of a physical quantity that should be detected (pitching, rolling, yaw, error in the X-Y direction, or a similar physical quantity), the counts of laser light sources and light sensors can be changed. For example, even the one light sensor 17 can detect the error in the X-Y direction. In addition to this, to obtain data regarding the inclination, such as pitching, rolling, and yaw, the count of the light sensors 17 needs to be at least two pieces or more. Using only one light sensor, the inclination of the apparatus or a similar inclination can be sensed by another sensor (an electronic bubble tube, a gyro sensor, or a similar sensor).

The laser light sources 16A to 16D are installed to the lower surface of the ascending/descending table 14. The laser light sources 16A to 16D emit laser light vertical to the principal plane of the shaping stage 13 and downward along the Z direction. On the shaping stage 13, the above-described light sensors 17A to 17D are arranged. The light sensors 17A to 17D are arranged on an optical path of the laser light from the laser light sources 16A to 16D.

Instead of installing the laser light sources 16A to 16D to the lower surface of the ascending/descending table 14, installing the laser light sources 16A to 16D to the lower surface of the XY table 12 is also possible. Briefly, it is only necessary that the laser light sources 16A to 16D be installed to a member that moves in accordance with the movement of the ascending/descending table 14.

Additionally, instead of being arranged on the shaping stage 13, the light sensors 17A to 17D may be arranged on the frame 11 downward of the shaping stage 13. Further, inverse from the above-described configuration, while the light sensors 17A to 17D may be installed at the lower surface of the ascending/descending table 14, the laser light sources 16A to 16D may be installed on the shaping stage 13 side. Briefly, it is only necessary that any one of the laser light source 16 and the light sensor 17 moves in accordance with the movement of the ascending/descending table 14 and the other is arranged at a fixed position regardless of the movement of the ascending/descending table 14.

The light sensors 17A to 17D are sensors having a function to two-dimensionally detect a barycentric position of a beam spot of the laser light received from the laser light sources 16A to 16D. The light sensors 17A to 17D are, for example, a CCD or CMOS sensor. Alternatively, instead of the two-dimensional sensor such as the CCD and CMOS sensors, a photodiode array where a plurality of photodiodes are arrayed in a matrix pattern can also be employed. The laser light from the laser light sources 16A to 16D is excellent in straightness. However, by ascending and descending the position of the ascending/descending table 14, the beam spot diameter slightly changes. In view of this, the detection of the barycentric position of the beam spot allows accurately comprehending the position of the ascending/descending table 14 regardless of the change in the beam spot diameter. Additionally, measurement of the spread of the beam allows confirming a parallelism between the shaping stage 13 and the ascending/descending table 14.

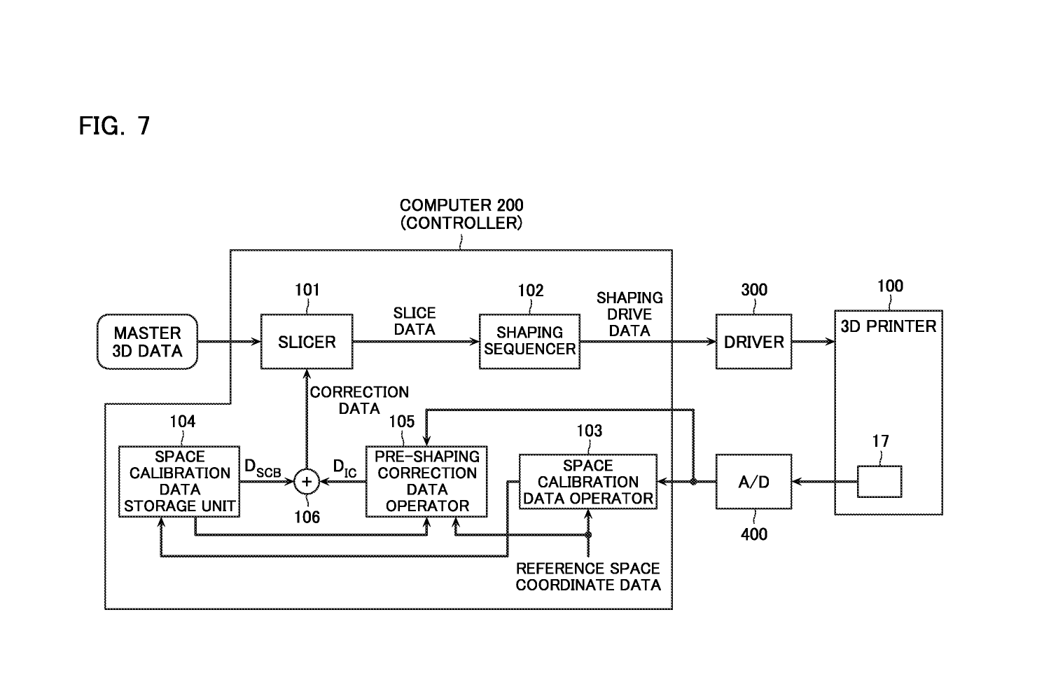

FIG. 7 is a function block diagram illustrating the configuration of the computer 200. The computer 200 processes the sensing signals from the light sensors 17A to 17D to perform data correction. The computer 200 includes a slicer 101, a shaping sequencer 102, a space calibration data operator 103, a space calibration data storage unit 104, a pre-shaping correction data operator 105, and an adder 106. These configurations can be achieved by a computer program inside the computer.

The slicer 101 is a part having a function of converting the master 3D data into a plurality of slice data in accordance with the coordinate system. The slice data is transmitted to the shaping sequencer 102 at a part latter than the slicer 101. The shaping sequencer 102 converts the slice data into shaping drive data to control the driver 300. In accordance with this shaping drive data, the driver 300 drives the XY stage 12, the ascending/descending table 14, and the shaping head 25.

An A/D converter 400 converts the sensing signals from the light sensor 17 (17A to 17D) into digital data and provides the digital data to the space calibration data operator 103. In accordance with the input digital data, the space calibration data operator 103 specifies the shaping space coordinate indicative of the shaping space specified by the 3D printer 100. The space calibration data operator 103 operates a difference between this shaping space coordinate and a reference space coordinate that specifies the master 3D data as space calibration data D_{SCB}. The space calibration data storage unit 104 stores the operated space calibration data D_{SCB}. This space calibration data D_{SCB} is operated in a pre-product-shipment setting operation, which is performed before the product shipment of the 3D printer 100 or in an initial setting operation, which is performed after the product shipment and before the start of use.

In the pre-shaping setting operation, which is performed before actually shaping the shaped object, the pre-shaping correction data operator 105 specifies the shaping space coordinate (shaping space coordinate immediately before the start of shaping operation) in accordance with the digital data input from the A/D converter 400. The pre-shaping correction data operator 105 specifies a difference between this shaping space coordinate and the reference space coordinate. Further, the pre-shaping correction data operator 105 operates the difference between this difference and the above-described space calibration data D_{SCB} as pre-shaping correction data D_{IC}.

The adder 106 adds the space calibration data D_{SCB}, which is stored in the space calibration data storage unit 104, and the pre-shaping correction data D_{IC}, which is operated by the pre-shaping correction data operator 105, to generate correction data and provides the correction data to the slicer. This correction data can eliminate the shift between the shaping space coordinate and the reference space coordinate. This correction data also further offsets an influence from the deformation in the shaping space from the product shipment or the initial setting. This allows exactly shaping the shaped object into the master 3D data regardless of the distortion of the 3D printer 100.

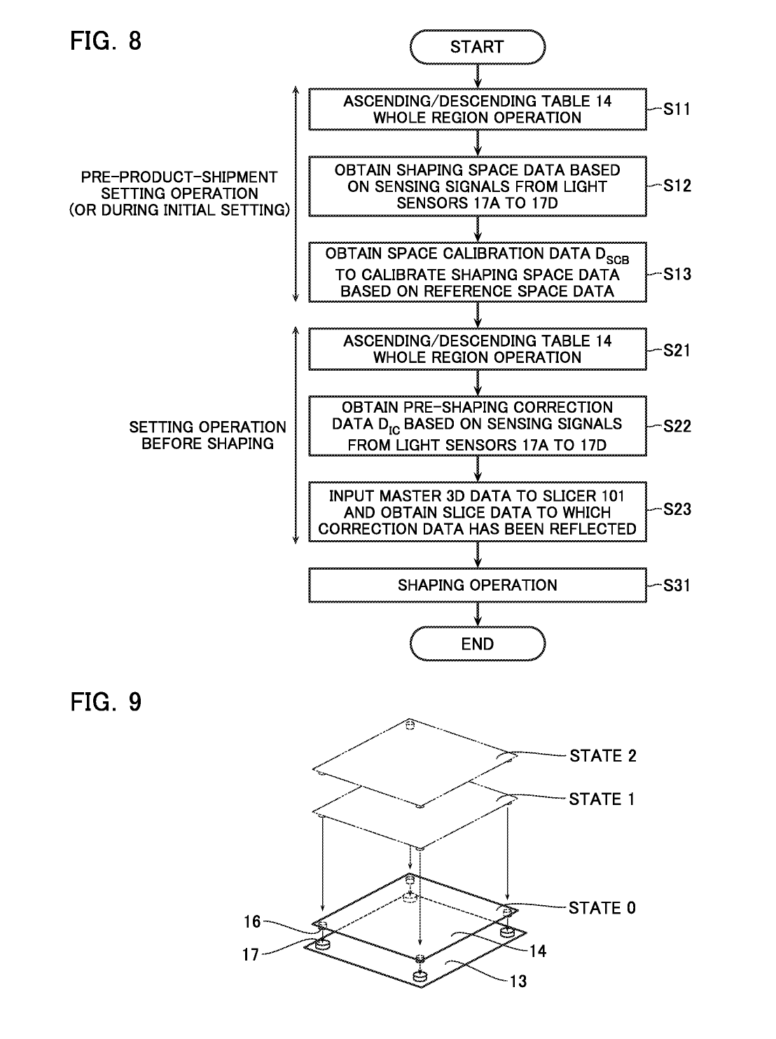

FIG. 8 is a flowchart illustrating operations by the three-dimensional shaping apparatus of the first embodiment. As described above, the three-dimensional shaping apparatus of the embodiment obtains the above-described space calibration data D_{SCB} in the pre-product-shipment setting operation, which is performed before the product shipment, or in the initial setting operation, which is performed before the start of product use. Afterwards, the three-dimensional shaping apparatus obtains the above-described pre-shaping correction data D_{IC} by the pre-shaping setting operation, which is performed before the shaping operation.

As illustrated in FIG. 8, the pre-product-shipment setting operation or the initial setting operation first moves the ascending/descending table 14 across the whole region of the range of motion (S11). During the whole region operation, the sensing signals from the light sensors 17A to 17D are obtained at predetermined intervals (S12). Specifically, when moving the ascending/descending table 14 from downward to upward, in the case where the ascending/descending table 14 is at the lowest layer (state: 0), the sensing signals from the light sensors 17A to 17D are obtained. The A/D converter 400 converts the sensing signals into the digital data and inputs the digital data to the space calibration data operator 103. Then, the ascending/descending table 14 is gradually ascended. The sensing signals from the light sensors 17A to 17D are obtained at respective positions (state 1, 2, . . . n). The sensing signals are input to the space calibration data operator 103. This obtains the shaping space coordinate data of the 3D printer 100 and obtains the space calibration data D_{SCB} (S13).

The pre-shaping setting operation, which is performed before the start of the shaping operation, similarly to S11, moves the ascending/descending table 14 across the whole region of the range of motion (S21). During the whole region operation, the pre-shaping setting operation obtains the sensing signals from the light sensors 17A to 17D at the predetermined intervals. The A/D converter 400 converts the sensing signals into the digital data and inputs the digital data to the pre-shaping correction data operator 105, thus obtaining the pre-shaping correction data D_{IC} (S22). Based on the space calibration data D_{SCB} and the pre-shaping correction data D_{IC} thus obtained, the adder 106 calculates the correction data. Adding this correction data, the slicer 101 calculates the slice data (S23). Based on the slice data thus calculated, the shaping operation is performed (S31).

### Effect

As described above, the three-dimensional shaping apparatus of this first embodiment preliminary obtains the space calibration data D_{SCB} to which the distortion of the shaping space of the 3D printer 100 has been reflected before the product shipment or during the initial setting. Additionally, at the phase prior to the shaping operation as well, the three-dimensional shaping apparatus obtains the pre-shaping correction data D_{IC} to which the distortion of the shaping space at the shaping operation has been reflected. Based on these data, the three-dimensional shaping apparatus can correct the slice data. This allows exactly shaping the shaped object into the master 3D data regardless of the distortion of the 3D printer 100.

### Second Embodiment

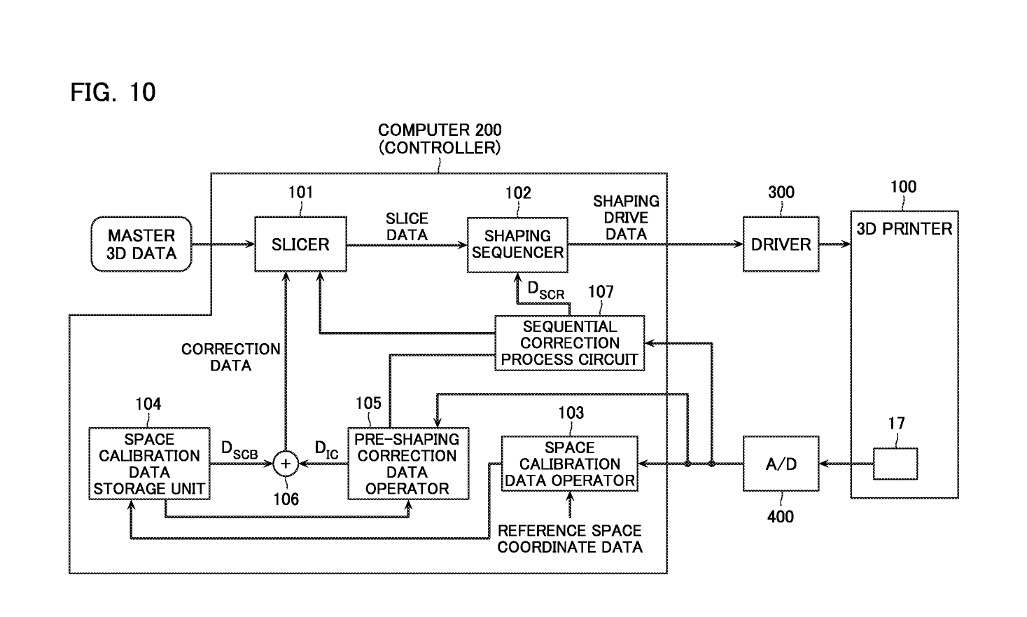

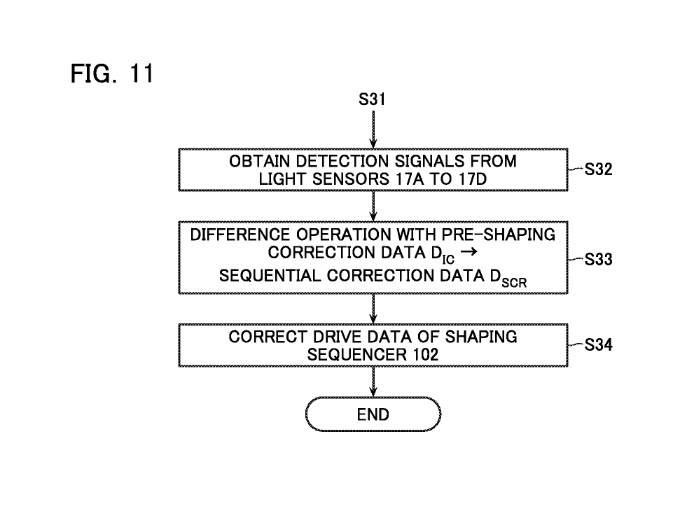

Next, the following describes a three-dimensional shaping apparatus according to the second embodiment of the present invention with reference to FIG. 10 and FIG. 11. The structure of the 3D printer 100 in the three-dimensional shaping apparatus is approximately identical to the 3D printer 100 of the first embodiment (FIG. 1 to FIG. 4). Accordingly, the following omits the detailed description of the 3D printer 100. Note that the second embodiment differs from the first embodiment in the structure and the operation of the computer 200. Specifically, the three-dimensional shaping apparatus according to the second embodiment obtains the pre-shaping correction data D_{IC} before the start of the shaping operation. After that, the three-dimensional shaping apparatus obtains data of the shaping space coordinate also in the middle of the shaping operation using the light sensors 17A to 17D. In view of this, the three-dimensional shaping apparatus performs correction sequentially in the middle of the shaping operation. In this respect, the second embodiment differs from the first embodiment.

FIG. 10 is a function block diagram illustrating the configuration of the computer 200 of the second embodiment. Like reference numerals designate identical elements to the elements of the first embodiment (FIG. 7). Therefore, the overlapped description will not be further elaborated here. In addition to the configuration of the first embodiment, this second embodiment further includes a sequential correction process circuit 107. This sequential correction process circuit 107 is a circuit that performs correction in the middle of the shaping operation. The sequential correction process circuit 107 then provides the correction data to the shaping sequencer 102. Following the provided correction data, the shaping sequencer 102 corrects the shaping drive data and provides the corrected shaping drive data to the driver 300. Accordingly, in the case where the shaping space coordinate of the 3D printer 100 changes in the middle of the shaping operation due to, for example, the change in weight of the shaped object itself or the change in weight balance, the apparatus of this second embodiment can reflect the change to the shaped object. When determining that the change during the shaping operation is greater than a predetermined value from the correction data, it is also possible to transmit the correction data to the slicer 101, not transmitting the correction data to the shaping sequencer 102, to modify the slice data again. Alternatively, instead of this or in addition to this, whether to cancel the shaping or not can also be determined. The cancel can be determined by the computer 200 itself or can be manually determined by an operator.

FIG. 11 illustrates the flowchart showing operations of the second embodiment. The second embodiment performs the operations identical to the first embodiment (FIG. 8). Then, the second embodiment performs the operations shown in FIG. 11 during the shaping operation. That is, the second embodiment obtains the detection signals from the light sensors 17A to 17D also after the start of the shaping operation similarly to the operations at S12 and S22 in FIG. 8 (S32). Then, the A/D converter 400 converts these detection signals into the digital data to input the digital data to the sequential correction process circuit 107. Following the input digital data, the sequential correction process circuit 107 specifies the shaping space coordinate (shaping space coordinate during the shaping operation). The sequential correction process circuit 107 specifies a difference between this shaping space coordinate and the reference space coordinate. The sequential correction process circuit 107 further operates a difference between this difference and the above-described pre-shaping correction data D_{IC} as sequential correction data D_{SCR} (S33). This sequential correction data D_{SCR} is transmitted to the shaping sequencer 102, thus correcting the shaping drive data (S34).

This embodiment can obtain the effects similar to the first embodiment. Additionally, this embodiment further senses the change in the shaping space of the 3D printer 100 during the shaping operation, ensuring the shaping operation according to this change. Accordingly, compared with the first embodiment, the second embodiment ensures further accurate shaping.

### Third Embodiment

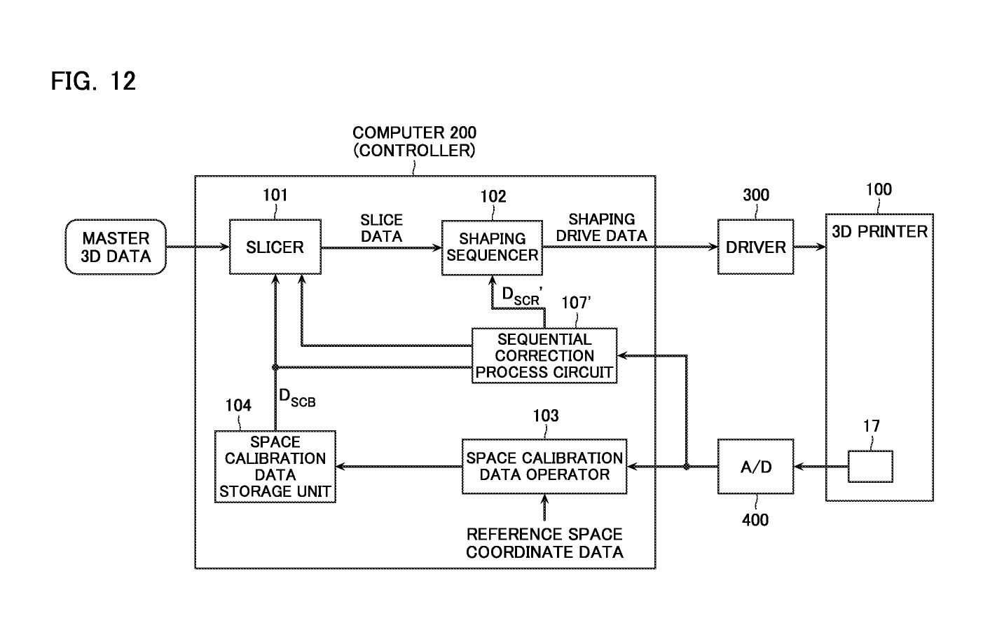

Next, the following describes a three-dimensional shaping apparatus according to the third embodiment of the present invention with reference to FIG. 12. The structure of the 3D printer 100 in the three-dimensional shaping apparatus is approximately identical to the 3D printer 100 of the first embodiment (FIG. 1 to FIG. 4). Accordingly, the following omits the detailed description of the 3D printer 100. Note that the third embodiment differs from the first embodiment in the structure and the operation of the computer 200.

FIG. 12 is a function block diagram illustrating a configuration of the computer 200 of the third embodiment. Like reference numerals designate identical elements to the elements of the first embodiment (FIG. 7). Therefore, the overlapped description will not be further elaborated here. Different from the first embodiment, this third embodiment omits the pre-shaping correction data operator 105. Instead of the pre-shaping correction data operator 105, the third embodiment includes a sequential correction process circuit 107′ similar to the second embodiment. That is, in this third embodiment, the space calibration data operator 103 operates the space calibration data D_{SCB} in the pre-product-shipment setting operation or the initial setting operation and the space calibration data storage unit 104 stores the space calibration data D_{SCB}. However, the pre-shaping correction data D_{IC} is not operated immediately before the shaping operation. The correction by the slicer 101 is performed only by the space calibration data D_{SCB}.

When starting the shaping operation, the detection signals from the light sensors 17A to 17D are detected as needed during execution of the shaping operation. Accordingly, the data of the shaping space coordinate of the 3D printer 100 is comprehended. In accordance with this, sequential correction data D_{SCB}′ is operated and used for correction by the shaping sequencer 102.

According to this embodiment, instead of not operating the pre-shaping correction data D_{IC} by the pre-shaping setting operation, the sequential correction data D_{SCR}′ is obtained during the shaping operation. Based on this data, the shaping sequencer 102 performs the correction, ensuring obtaining the effects similarly to the above-described embodiments.

While certain embodiments of the present invention have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

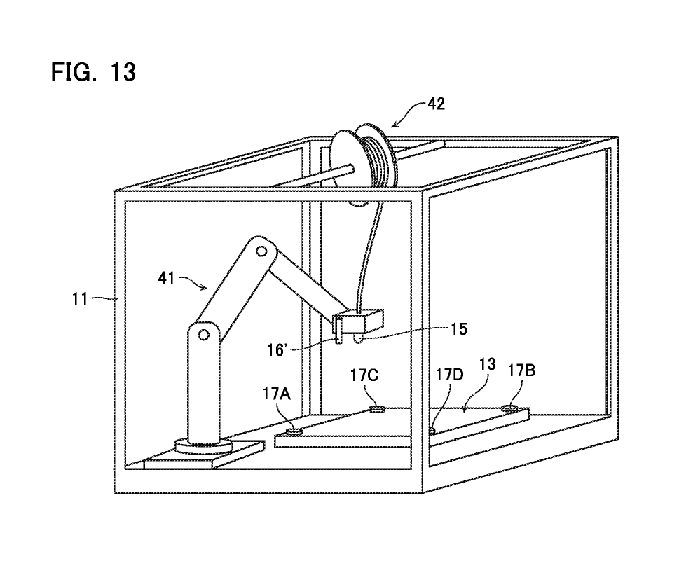

For example, with the above-described embodiments, the moving mechanism of the 3D printer 100 includes the guide shafts 15, which extend vertically to the shaping stage 13, the ascending/descending table 14, which moves along the guide shafts 15, and the XY table 12. However, the moving mechanism of the 3D printer 100 of the present invention is not limited to this. For example, as illustrated in FIG. 13, the moving mechanism of the 3D printer 100 can include a multiaxis arm 41. The multiaxis arm 41 has a fixed end at the bottom surface of the frame 11.

The guide shaft 15 similar to the above-described embodiments can be mounted to a moving end (ascending/descending unit) of this multiaxis arm 41. In the example illustrated in the drawing, a filament rolling up portion 42 is rotatably coupled to the upper portion of the frame 11 around the rotation shaft. The filament rolling up portion 42 is coupled to the guide shaft 15. This is merely an example. Similarly to the above-described embodiments, a filament holder may be mounted in the multiaxis arm 41.

Further, a laser light source 16′ similar to the laser light source 16 of the above-described embodiments can be provided to the lower surface of the moving end (ascending/descending unit) to which the guide shaft 15 is mounted. The light sensors 17A to 17D on the shaping stage 13 receive the light from this laser light source 16′. Similarly to the above-described embodiments, the light sensor 17 may be arranged at the lower surface of the moving end, and the laser light source 16 may be arranged on the shaping stage 13.

According to the above-described configuration, the operations similar to the above-described embodiments can be performed. That is, it is only necessary that the present invention is configured as follows. The present invention includes the shaping stage, the ascending/descending unit, and the shaping head. The shaped object is to be placed on the shaping stage. The ascending/descending unit is movable at least in the vertical direction with respect to the shaping stage. The shaping head is mounted to the ascending/descending unit. Any one of the light sensor or the laser light source is movably mounted in accordance with a movement of this ascending/descending unit. Meanwhile, another is fixedly arranged in a relationship with the shaping stage. As the coordinate system that specifies the shaping space and the reference space, instead of using an orthogonal coordinate system, a polar coordinate system may be used.

What is claimed is:

1. A three-dimensional shaping apparatus, comprising:
a shaping stage configured to carry a shaped object;
an ascending/descending unit movable at least along a vertical direction with respect to the shaping stage;
a shaping head mounted on the ascending/descending unit;
a light sensor; and
a light source configured to emit light directed toward the light sensor; wherein
one of either the light sensor or the light source is mounted movable in accordance with movement of the ascending/descending unit, while the other of either the light sensor or the light source is disposed fixedly relative to the shaping stage.

2. The three-dimensional shaping apparatus according to claim 1, further comprising:
a driver configured to drive the ascending/descending unit and the shaping head;
a slicer configured to convert three-dimensional shape data into slice data;
a shaping sequencer configured to generate drive data for driving the driver based on the slice data; and
a correction unit configured to mathematically derive, in accordance with an output signal from the light sensor, a shaping space coordinate system indicating a shaping space on the shaping stage, to correct the slice data based on data relating to the shaping space coordinate system.

3. The three-dimensional shaping apparatus according to claim 2, further comprising:
a sequential correction processor configured to generate a sequential correction signal based on an output signal from the light sensor during shaping of the shaped object; wherein
the shaping sequencer is configured to modify the drive data based on the sequential correction signal.

4. The three-dimensional shaping apparatus according to claim 2, wherein:
the correction unit is configured to:
compute, based on an output signal from the light sensor obtained by moving the ascending/descending unit during pre-product-shipment setting, or during initial setting prior to start of use, of the three-dimensional shaping apparatus, space calibration data indicating a difference between the shaping space coordinate system and a reference coordinate system;
further to compute, based on an output signal from the light sensor obtained by moving the ascending/descending unit in a pre-shaping setting operation before the shaping operation is commenced, pre-shaping correction data for correcting the space calibration data; and
correct the slice data based on the space calibration data and the pre-shaping correction data.

5. The three-dimensional shaping apparatus according to claim 4, further comprising:
a sequential correction processor configured to generate a sequential correction signal based on an output signal from the light sensor during shaping of the shaped object; wherein
the shaping sequencer is configured to modify the drive data based on the sequential correction signal.

6. The three-dimensional shaping apparatus according to claim 1, wherein
the light sensor is configured to detect a barycentric position of a beam spot formed by a light beam from the light source.

7. The three-dimensional shaping apparatus according to claim 2, wherein
the light sensor is configured to detect a barycentric position of a beam spot formed by a light beam from the light source, and
the correction unit is configured to mathematically derive the shaping space coordinate system based on fluctuation of the barycentric position.

8. The three-dimensional shaping apparatus according to claim 1, further comprising
a guide shaft that extends approximately perpendicularly to the shaping stage, wherein
the ascending/descending unit is configured movable along the vertical direction along the guide shaft, and
the shaping head is configured movable along a first direction and a second direction with respect to the ascending/descending table, the first direction and the second direction intersecting the vertical direction.

9. The three-dimensional shaping apparatus according to claim 8, further comprising:
a driver configured to drive the ascending/descending unit and the shaping head;
a slicer configured to convert three-dimensional shape data into slice data;
a shaping sequencer configured to generate drive data for driving the driver based on the slice data; and
a correction unit configured to mathematically derive, in accordance with an output signal from the light sensor, a shaping space coordinate system indicating a shaping space on the shaping stage, to correct the slice data based on data relating to the shaping space coordinate system.

10. The three-dimensional shaping apparatus according to claim 9, wherein:
the correction unit is configured to:
compute, based on an output signal from the light sensor obtained by moving the ascending/descending unit during pre-product-shipment setting, or during initial setting prior to start of use, of the three-dimensional shaping apparatus, space calibration data indicating a difference between the shaping space coordinate system and a reference coordinate system;
further to compute, based on an output signal from the light sensor obtained by moving the ascending/descending unit in a pre-shaping setting operation before the shaping operation is commenced, pre-shaping correction data for correcting the space calibration data; and
correct the slice data based on the space calibration data and the pre-shaping correction data.

11. A method for calibrating a three-dimensional shaping apparatus including a shaping stage configured to carry a shaped object, an ascending/descending unit, and a shaping head, the ascending/descending unit being movable at least along a vertical direction with respect to the shaping stage, the shaping head being mounted on the ascending/descending unit, the method comprising:
emitting light from a first position;
receiving the light in a light sensor arranged in a second position;
moving the ascending/descending unit vertically;
measuring change in received-light status of the light in the light sensor; and
based on the change in received-light status, mathematically deriving a shaping space coordinate system indicating a shaping space on the shaping stage,
one of either the first position or the second position being a position movable in accordance with movement of the ascending/descending unit, while the other of either the first position or the second position being fixed relative to the shaping stage.

12. The method for calibrating a three-dimensional shaping apparatus according to claim 11, further comprising:
converting three-dimensional shape data into slice data;
generating drive data for driving the ascending/descending unit based on the slice data; and
correcting the slice data based on the shaping space coordinate system.

13. The method for calibrating a three-dimensional shaping apparatus according to claim 12, further comprising:
computing, based on an output signal from the light sensor obtained by moving the ascending/descending unit, space calibration data indicating a difference between the shaping space coordinate system and a reference coordinate system;
computing, based on an output signal from the light sensor obtained by moving the ascending/descending unit, pre-shaping correction data for correcting the space calibration data; and
correcting the slice data based on the space calibration data and the pre-shaping correction data.

14. The method for calibrating of a three-dimensional shaping apparatus according to claim 12, further comprising:
generating a sequential correction signal based on an output signal from the light sensor during shaping of the shaped object; and
modifying the drive data based on the sequential correction signal.
